(19) United States
(12) Patent Application Publication
(10) Pub. No.: US 2013/0180166 A1
(43) Pub. Date: Jul. 18, 2013

(54) HYBRID SYSTEM FOR ENHANCING ALGAL GROWTH USING VERTICAL MEMBRANES

(71) Applicants: David J. Bayless, Athens, OH (US); Ben Stuart, Athens, OH (US)

(72) Inventors: David J. Bayless, Athens, OH (US); Ben Stuart, Athens, OH (US)

(73) Assignee: OHIO UNIVERSITY, Athens, OH (US)

(21) Appl. No.: 13/825,561

(22) PCT Filed: Sep. 26, 2011
(86) PCT No.: PCT/US11/53254

§ 371 Date: Mar. 22, 2013

Related U.S. Application Data
(60) Provisional application No. 61/385,981, filed on Sep. 24, 2010.

(51) Int. Cl. A01G 33/00

(52) U.S. Cl. CPC A01G 33/00
USPC 47/1.4

(57) ABSTRACT

A method for enhancing gas-to-liquid transfer rate and algal growth using vertical membranes suspended over a pond, wherein the membranes are formed of fibers. An aqueous solution is applied to the top edges of the membranes through a series of headers. The membranes are exposed to a stream of gas containing soluble gas species as the aqueous solution migrates downwardly through the membranes by virtue of gravity-assisted capillary action. The aqueous solution collects the soluble gases from the gas stream, thus promoting the growth of photosynthetic organisms on the membranes and in the pond. The membranes facilitate a gradual introduction of the aqueous solution into the pond at a preferred rate of about 1.3 gallons per minute per linear foot of membrane for optimizing the transfer soluble species from gaseous phase to aqueous phase without rapidly acidifying the pond and harming the phototrophic organisms.

### BACKGROUND OF THE INVENTION

This invention relates generally to the field of gas-to-liquid transfer and more particularly to an algal growth method that employs vertical membranes for introducing water that is enriched in CO₂ and other soluble gases into a pond or raceway below.

Enhanced natural sinks are economically competitive and environmentally safe carbon sequestration options for fossil-fuel burning power plants, because they neither require pure CO₂, nor incur the costs (and dangers) of separation, capture, and compression of CO₂ gas. Among the options for enhanced natural sinks, optimizing the growth of existing photosynthetic organisms in an engineered system is low risk, low cost, and benign to the environment. Additionally, an engineered photosynthesis system has the advantage of being at the source of the emissions to allow measurement and verification of the system effects, rather than being far removed from the emissions source, as is the case with forest-based and ocean-based natural sinks. The invention is suitable for application at existing and future fossil units, as well as for gas streams containing other soluble contaminant gases (such as ammonia, SOx, NOx, and/or others).

Even though CO₂ is a fairly stable molecule, it is also the basis for the formation of complex sugars (food) through photosynthesis in green plants, algae, and cyanobacteria. The relatively high content of CO₂ in flue gas (approximately 14% compared to 400 ppm in ambient air) has been shown to significantly increase growth rates of certain species of cyanobacteria. Therefore, this photosynthetic process is ideal for a contained system engineered to use specially selected strains of cyanobacteria to maximize CO₂ conversion to biomass and emitting less of the greenhouse gas to the atmosphere.

The production of microalgae as a feedstock for the mitigation of carbon dioxide emission and production of biofuels requires a consistent and controlled supply of inorganic carbon, primarily CO₂, to the microalgae (or cyanobacteria) culture. The CO₂ must be introduced to the microalgae's growth medium (typically water) in a way that does not abruptly and significantly reduce the pH of the growth medium, which is prone to happen as carbonic acid forms when CO₂ is absorbed by, and reacts with water.

For most pond and raceway systems that employ algal production, CO₂ is added to the growth medium via bubbling (also known as “sparging”). This process requires nearly pure, food-grade CO₂, which is very expensive. Moreover, while sparging is generally an effective method for transferring CO₂ to water, it also rapidly and significantly changes the pH of the water in the vicinity of the bubbles. This can be detrimental to strains of algae that respond negatively to rapid acidification.

Conversely, ponds or raceways that do not employ sparging as a method of CO₂ introduction depend on the transfer of CO₂ from the surrounding atmosphere into the water of the pond or raceway below. This is a relatively slow process given that the concentration of CO₂ in air is relatively low (400 ppm) and that the surface area of a pond or raceway is relatively small.

Further, other compounds are needed for the successful growth of phototrophic organisms, such as soluble nitrogen and phosphorus species. The addition of these species as fertilizer is very costly, but could be supplemented or replaced by transfer of such species from gas streams where these species are considered pollutants.

In view of the foregoing, it would be advantageous to provide a means for introducing a large quantity of CO₂ and/or other gas species into the pond or raceway of an algal growth system in a manner that does not abruptly and significantly increase the acidity of the water.

### BRIEF SUMMARY OF THE INVENTION

In accordance with the purposes of the present invention, there is provided a hybrid algal growth method for optimizing the mass transfer rate of soluble gas species into media (e.g. water with or without added salts) in a manner that promotes the growth of microalgae and phototrophic bacteria in both suspended and attached modes.

The inventive method employs a plurality of vertical or near-vertical membranes having lower edges that are in contact or near contact with water contained in a pond or other receptacle below the membranes. The membranes are exposed to a stream of gas containing soluble elements or compounds, such as CO₂, while a growth solution comprising water and soluble salts is pumped into headers that are located above, and that are in fluid communication with, the membranes. Gravity-assisted capillary action uniformly wets the membranes and establishes a gradual flow of the solution into the pond at a preferred rate of about 1.3 gallons of growth solution per linear foot of membrane per minute. This flow rate of the solution on the specific structure of the woven membranes has been found to significantly increase the mass transfer rate of CO₂ from the gas stream to the aqueous solution flowing through the membrane relative to the vertical membrane system described in U.S. Pat. No. 6,667,171.

Additionally, the configuration of the system and the flow rate of the growth solution introduces CO₂ and other soluble gases into the pond at a more gradual rate than conventional sparging methods while eliminating the need for gas compression. The resulting, gradual change in the pH of the pond reduces the “shock” and associated “lag” experienced by some algal culture, thus increasing overall algal productivity in the pond.

The inventive method makes pH control far simpler, provides a more robust growth environment for cyanobacteria, and eliminates the need for expensive buffering solutions, all while increasing the amount of inorganic carbon that is available to algae. Furthermore, the vertical membranes of the system provide an excellent growing surface for phototrophs that grow in attached mode (i.e. those that cling to substrates while growing). This provides additional surface area for phototrophic conversion of CO₂ to biomass, allows the system to be more biologically (and thus economically) diverse, and allows organisms that grow best in a suspended mode to “own” the pond, while those that grow best in an attached mode to “own” the membranes. Further, in the case of soluble species of nitrogen, phosphorus and sulfur, the transfer of such species into the growth medium could be used to enhance algal growth or it could obviate the need for expensive fertilizer or supplements that would otherwise be required to grow the algae at a highly productive rate or both.

### BRIEF DESCRIPTION OF THE SEVERAL VIEWS OF THE DRAWINGS

FIG. 1 is a diagram illustrating the carbon sequestration process.

FIG. 2 is a diagram illustrating a preferred embodiment of the membrane arrangement of the present invention within a containment chamber.

FIG. 3 is a side view in section illustrating the membrane arrangement in the aqueous solution delivery system.

FIG. 4 is a diagram illustrating flue gas flowing over a membrane.

FIG. 5 is a chart illustrating the results of carbon transfer tests of membrane-assisted and non-membrane-assisted carbon sequestration systems.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

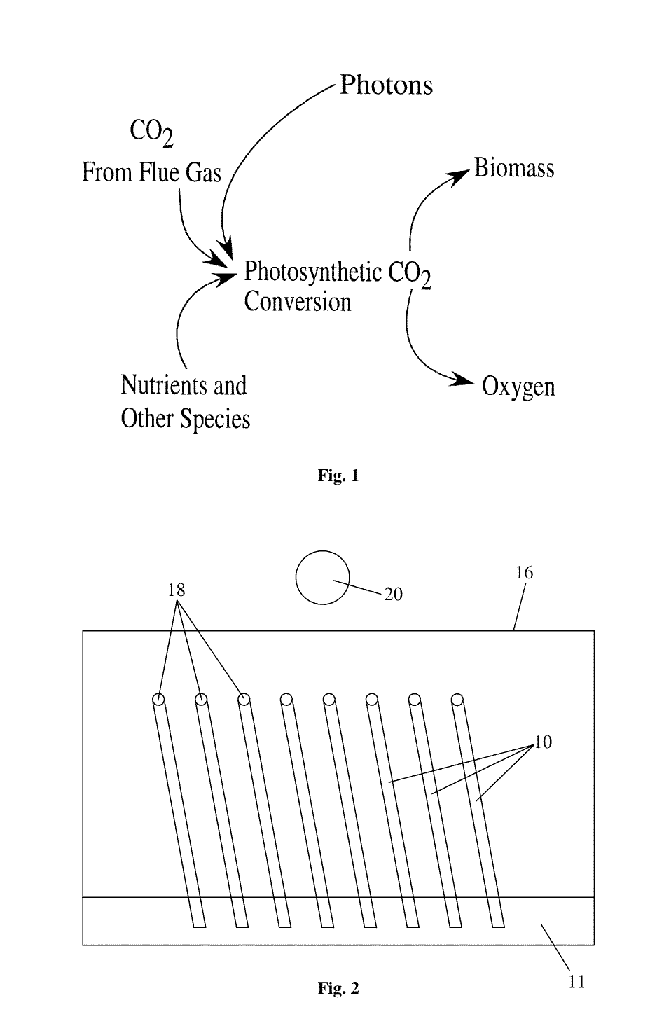

A diagram of the well-understood process of photosynthesis is shown in FIG. 1. Photosynthesis reduces carbon by converting it to biomass. As shown in FIG. 1, if the composition of typical cyanobacteria (normalized with respect to carbon) is CH_{1.8}N_{0.17}O_{0.56}, then one mole of CO₂ is required for the growth of one mole of cyanobacteria. Based on the relative molar weights, the carbon from 1 kg of CO₂ could produce increased cyanobacteria mass of 25/44 kg, with 32/44 kg of O₂ released in the process, assuming O₂ is released in a one-to-one molar ratio with CO₂. A conservative estimate indicates that a 2,000,000 m² facility powered by collected solar energy could process 25% of the effluent CO₂ from a 200 MW coal-fired power plant, producing over 140,000 tons of dry biomass per year. Dried biomass could be used in the production of fertilizer, fermented or gasified to produce alcohols and light hydrocarbons, or directly as a fuel to meet biomass mandates in pending deregulation legislation. Therefore, a photosynthetic system provides critical oxygen renewal along with the recycling of carbon into potentially beneficial biomass.

Optimization of this process in the present invention is based on design of a mechanical system (described in greater detail below) that efficiently utilizes photosynthetic microbes. Photosynthetic microbes are microorganisms, such as algae and cyanobacteria, which harness photons to fix carbon-containing gas into carbon-based biomass.

Referring to FIG. 2, a mechanical system similar to the one described in U.S. Pat. No. 6,667,171 to Bayless et al. (herein incorporated by reference) is employed for facilitating the methods of the present invention. The system includes a containment chamber 16 that houses a plurality of membranes 10 suspended above a pond 11. The membranes 10 are preferably suspended from the headers 25 of a manifold water delivery system (described in greater detail below) in a generally vertical or near-vertical orientation with a lower edge of each membrane 10 in contact with water in the pond 11 (or in near contact with the water). Cyanobacteria are distributed on the surfaces of the membranes 10 and within the pond 11. Each membrane 10 is preferably rectangular in shape and measures about 10 feet tall by about 20 feet wide, but the dimensions in each direction can vary from about 2 to at least 30 feet. It is contemplated that the membranes 10 can have any dimensions that are practicable given a particular plant setting, flow rate, and other limitations known to the person having ordinary skill in the art.

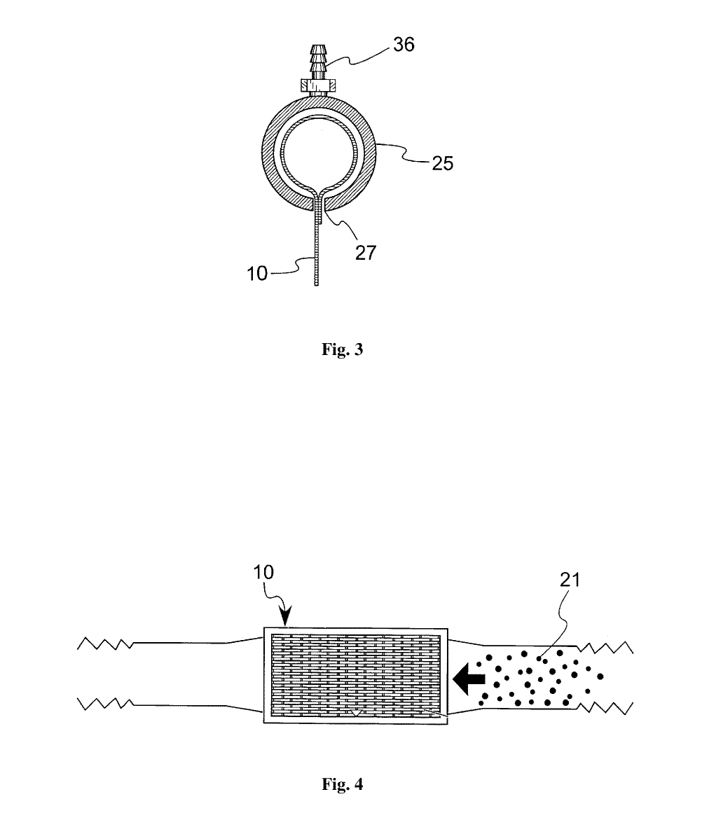

FIG. 3 shows the preferred arrangement for the manifold water delivery system within the containment chamber 16. A header 25 receives a nutrient-rich, microbial growth solution from the supply line 36. The solution flows to the membrane 10 through an opening 27 in the header 25. A top edge of the membrane 10 is held in contact with the inside of the header 25, and the rest of the membrane 10 is draped through the opening 27. Because the membrane 10 has capillary passages (described below) through which the solution can flow, the solution never has to be sprayed if spraying is desired to be avoided.

Referring back to FIG. 2, the membranes 10 are optimized for transferring CO₂ into the water located below the membranes 10 at a gradual, controlled rate, thereby promoting the growth of the photosynthetic cyanobacteria on the surface of the pond 11, in a so-called “suspended mode,” as well as on the surfaces of the membranes 10, in a so-called “attached mode.” To that end, the membranes 10 are preferably formed of woven polypropylene fibers. Polypropylene was selected because, in addition to being non-toxic and supporting adhesion of the microbes employed in the inventive system, it is wettable and facilitates the spreading of aqueous solution applied thereto through capillary action. That is, when a membrane 10 formed of the polypropylene fibers is wetted at its top edge with the aqueous, microbial growth solution (described below), the solution not only runs down the surface of the membrane 10 vertically, under the force of gravity, but also spreads across the membrane 10 horizontally, by virtue of capillary action through the spaces between the woven fibers.

The wettability of the membranes 10 thus impedes the downward migration of the aqueous solution through the membranes 10 by disrupting the downward flow of the solution as well as by encouraging lateral spreading of the solution. Impeding the flow of the solution in this manner is critical for facilitating optimal transfer of CO₂ and other soluble gas species from the gas stream to the solution flowing through membrane as well as for facilitating the gradual introduction of the solution, and the CO₂, ammonia and other chemicals contained therein, into the pond 11 below. Particularly, it has been found through experimentation that in order to optimize wettability for this purpose, the fibers of the membranes 10 should have a diameter that is approximately equal to the thickness of the boundary layer, or “film,” of growth solution that flows over the fibers. For example, the fibers of the preferred embodiment of the invention shown in FIG. 2 have a thickness of about 0.3 millimeters that substantially equals the thickness of the film of growth solution that flows over the fibers at the flow rate described below.

It is contemplated that the membranes 10 of the system can be formed of various materials other than polypropylene, including, but not limited to natural and synthetic (artificial) materials such as cotton, silica, or other polymers. It is preferred that the membrane material be inorganic in order to mitigate the growth of fungi. The material should also suit the specific microbes used, being non-toxic to the microbes and also supporting or inhibiting adhesion of the microbes for growth in the attached mode, depending upon design criteria. Furthermore, although the preferred membrane is woven, non-woven membranes of fibers are contemplated.

During operation of the system, the surfaces of the membranes 10 are exposed to a stream of carbon-containing gas 21 as shown in FIG. 4. CO₂ and other soluble species in the gas stream 21 are transferred to the growth solution flowing through the membranes 10 by virtue of surface contact. The membranes 10 significantly increase the amount of available surface contact area, and therefore the mass transfer rate of CO₂ to aqueous phase, relative to conventional algal growth systems that employ ponds or raceways that lack membranes.

It has been found through experimentation that in order to promote optimal transfer of CO₂ from the gas stream 21 to the membranes 10 to the pond 11, the flow rate of the growth solution through the membranes 10 should be about 1.3 gallons per minute per linear foot of membrane 10. That is, every minute about 1.3 gallons of growth solution should flow through a 1 foot long, horizontal section of each membrane 10. This is measured by measuring the number of gallons per minute flowing into the header 25, and then dividing by the horizontal length of the membrane 10. This flow rate, in combination with the membrane fiber size and film thickness described above, was found to be optimal for transferring a maximum amount of CO₂ from a gas stream into the pond 11 while mitigating rapid acidification of the pond that could “shock” the cyanobacteria therein. However, it is contemplated that the growth solution flow rate can be varied from this rate with diminishing advantage. If larger fibers are used in the membranes 10, a larger film layer can be used, and therefore a greater flow rate.

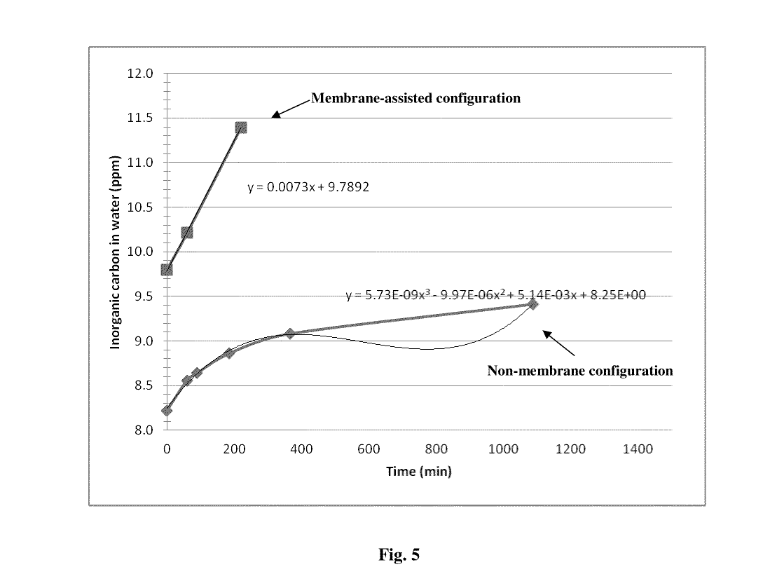

The gas-to-liquid mass transfer capability of the above-described system was tested in an experimental facility both with and without the membranes 10 in place above a raceway for the sake of comparison. Plain water was substituted for microbial growth solution and CO₂ was derived from an ambient, greenhouse atmosphere. The test data shown in the chart in FIG. 5 represents the average of three experimental runs, with all data being within 10% of the average at each sample point. The two curves represent measured inorganic carbon levels in the raceway water for experimental runs with and without the membranes 10 in place. The results show that the membrane mass transfer rate had both a significant (50%) increase in initial mass transfer rate compared to the non-membrane configuration, and that the rate was constant nearly until saturation, which differed greatly from the non-membrane configuration. As the inorganic carbon levels approached saturation for both configurations, the mass transfer rate was more than 250% higher in the membrane-assisted configuration. It is contemplated that this rate should be similar for other soluble gas-phase species.

The test results shown in FIG. 5 demonstrate that the membranes 10 virtually eliminate the water-side mass transfer resistance to carbon transfer. This was concluded because of the near straight-line mass transfer characteristics of the membrane configuration. Therefore, it could be surmised that the application of membranes 10 in the transfer of carbon from gas phase to aqueous phase would be substantially increased in a body of water that supports photosynthesis.

Referring back to the exemplary plant layout shown in FIG. 2, a light source 20, such as the sun or a fiber optic array, supplies photons to the microbes of the system for driving photosynthesis. The light source 20 may be positioned above the chamber 16 as in FIG. 2, or in a position relative to the membranes 10 to optimize cyanobacterial growth and carbon dioxide uptake. It is contemplated that the membranes 10 could be angled to reflect sunlight into the pond 11 during the early morning or late evening hours. While such reflection would be relatively trivial during the period of high sun, it would be significant when the sun is low in the sky, such as during sunrise or sunset when the sunlight would otherwise have a low incidence angle with respect to the pond surface. At low angles of incidence the light is far more likely to be reflected from the pond surface than absorbed, making photon capture by the autotrophic organism much more difficult. By using the membranes 10 as reflective surfaces, the number of photons available in the early morning and late evening hours can be significantly increased, thereby increasing the rate of algal growth in the pond 11.

In FIG. 2, each membrane 10 is similarly oriented in the containment chamber 16. The membranes 10 can be oriented at an angle of ninety degrees relative to the top of the chamber 16, but the angle may vary depending on the needs of a specific unit. The membranes 10 may be fixed in place within the chamber 16, movable in increments, or continuously movable to optimize exposure to the flue gas and/or light source. The orientation of the membranes 10 provides minimum power loss due to flow obstruction when in the containment chamber 16.

It is not contemplated that phototrophic organisms growing in attached mode will be harvested from the membranes 10 of the present invention, but such harvesting can be accomplished by way of the process described below. Harvesting is the removal of mature photosynthetic microbes from the membranes and the pond. Harvesting is advantageous because the rate of carbon dioxide consumption decreases as the growth rate of cyanobacteria slows. Therefore, harvesting cyanobacteria to make space for further growth maximizes carbon dioxide uptake. The harvesting method involves flushing the membranes 10 at periodic intervals with a large volume of liquid. The momentum from the large volume of flushing liquid is sufficient to overcome adhesive forces that hold the microbes on the membrane, so many of the microbes are displaced from the membranes 10.

Harvesting occurs in the containment chamber 16 by a differential pressure water supply system, which functions as a nutrient delivery drip system at low delivery pressures and algal harvesting system at high delivery pressures. Under normal conditions the membranes 10 are hydrated by capillary action. Under harvesting conditions, the fluid delivery action is increased, creating a high flow sheeting action that displaces a substantial percentage of the microbes from the membranes 10.

Harvesting that results in partial cleaning of the membranes 10 is preferred. Partial cleaning means that after cleaning, enough cyanobacteria remain adhered to repopulate the membranes 10. This is desirable to avoid a growth lag, thereby maximizing carbon dioxide uptake in the system. The harvested cells accumulate in a slurry at the bottom of the containment chamber 16. The harvested cells are removed, and fresh growth solution is applied to the young cells that remain on the membranes 10.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method for enhancing the mass transfer of at least one soluble gas specie from a gaseous phase to an aqueous phase using a system having at least one membrane formed of fibers mounted in a gas stream, a fluid reservoir below and in contact with the membrane, a plurality of photosynthetic microbes disposed on the membrane and in the fluid reservoir, a water and nutrient delivery device including a liquid-conveying conduit having at least one opening near a top edge of the membrane for delivering an aqueous solution in the conduit near the top edge of the membrane, wherein the membrane permits the aqueous solution to flow through the membrane by capillary action, the method comprising delivering the aqueous solution to the fluid reservoir through the membrane at a flow rate that is sufficient to create a film of aqueous solution flowing over the membrane of a thickness substantially equal to a thickness of at least some of the membrane fibers.

2. The method in accordance with claim 1, wherein the step of delivering the aqueous solution further comprises delivering the aqueous solution to the fluid reservoir through the membrane at a flow rate in a range of about 0.5 gallons to about 2.5 gallons per minute per horizontal foot of the membrane.

3. The method in accordance with claim 2, wherein the step of delivering the aqueous solution further comprises delivering the aqueous solution to the fluid reservoir through the membrane at a flow rate in a range of about 0.75 gallons to about 2.25 gallons per minute per horizontal foot of the membrane.

4. The method in accordance with claim 3, wherein the step of delivering the aqueous solution further comprises delivering the aqueous solution to the fluid reservoir through the membrane at a flow rate in a range of about 1 gallon to about 2 gallons per minute per horizontal foot of the membrane.

5. The method in accordance with claim 4, wherein the step of delivering the aqueous solution further comprises delivering the aqueous solution to the fluid reservoir through the membrane at a flow rate in a range of about 1.25 gallon to about 1.5 gallons per minute per horizontal foot of the membrane.

6. The method in accordance with claim 5, wherein the step of delivering the aqueous solution further comprises delivering the aqueous solution to the fluid reservoir through the membrane at a flow rate of about 1.3 gallons per minute per horizontal foot of the membrane.

7. The method in accordance with claim 1, further comprising orienting the membrane to reflect an optimal amount of light into the fluid reservoir.

8. The method in accordance with claim 1, further comprising flowing the aqueous solution over the fibers of the membrane with a boundary layer thickness in a range of about 0.1 millimeters to about 0.5 millimeters.

9. The method in accordance with claim 8, further comprising flowing the aqueous solution over the fibers of the membrane with a boundary layer thickness in a range of about 0.2 millimeters to about 0.4 millimeters.

10. The method in accordance with claim 9, further comprising flowing the aqueous solution over the fibers of the membrane with a boundary layer thickness of about 0.3 millimeters.

11. The method in accordance with claim 1, further comprising the step of including in the gas stream at least CO₂.

12. The method in accordance with claim 1, further comprising the step of including in the gas stream at least NOₓ.

13. The method in accordance with claim 1, further comprising the step of including in the gas stream at least SOₓ.

14. The method in accordance with claim 1, further comprising the step of including in the gas stream at least NH₃

15. An improved apparatus for enhancing the mass transfer of at least one soluble gas specie from a gaseous phase to an aqueous phase using a system having at least one membrane mounted in a gas stream, a fluid reservoir below and in contact with the membrane, a plurality of photosynthetic microbes disposed on the membrane and in the fluid reservoir, and an aqueous solution delivery device including a liquid-conveying conduit having at least one opening near a top edge of said at least one membrane for delivering an aqueous solution in the conduit near the top edge of the membrane, wherein the membrane permits the aqueous solution to flow through the membrane by capillary action, the improvement comprising the membrane being formed of fibers, wherein at least some of the fibers have a thickness that is substantially equal to the thickness of a boundary layer of aqueous solution that flows over the fibers.

16. The improved apparatus in accordance with claim 15, further comprising means for delivering the aqueous solution to the fluid reservoir through the membrane at a flow rate in a range of about 0.5 gallons to about 2.5 gallons per minute per horizontal foot of the membrane.

17. The improved apparatus in accordance with claim 16, further comprising means for delivering the aqueous solution to the fluid reservoir through the membrane at a flow rate in a range of about 0.75 gallons to about 2.25 gallons per minute per horizontal foot of the membrane.

18. The improved apparatus in accordance with claim 17, further comprising means for delivering the aqueous solution to the fluid reservoir through the membrane at a flow rate in a range of about 1 gallon to about 2 gallons per minute per horizontal foot of the membrane.

19. The improved apparatus in accordance with claim 18, further comprising means for delivering the aqueous solution to the fluid reservoir through the membrane at a flow rate in a range of about 1.25 gallons to about 1.5 gallons per minute per horizontal foot of the membrane.

20. The improved apparatus in accordance with claim 19, further comprising means for delivering the aqueous solution to the fluid reservoir through the membrane at a flow rate of about 1.3 gallons per minute per horizontal foot of membrane.

21. The improved apparatus in accordance with claim 15, wherein at least some of the fibers have a thickness in a range of about 0.1 millimeters to about 0.5 millimeters

22. The improved apparatus in accordance with claim 21, wherein at least some of the fibers have a thickness in a range of about 0.2 millimeters to about 0.4 millimeters.

23. The improved apparatus in accordance with claim 22, wherein at least some of the fibers have a thickness of about 0.3 millimeters.

24. The improved apparatus in accordance with claim 15, wherein said at least one soluble gas specie comprises CO₂.

25. The improved apparatus in accordance with claim 15, wherein said at least one soluble gas specie comprises NOₓ.

26. The improved apparatus in accordance with claim 15, wherein said at least one soluble gas specie comprises SOₓ.

27. The improved apparatus in accordance with claim 15, wherein said at least one soluble gas specie comprises NH₃
